(19) United States
(12) Patent Application Publication
(10) Pub. No.: US 2026/0126741 A1
(43) Pub. Date: May 7, 2026

(54) IMAGE FORMING APPARATUS

(71) Applicant: KYOCERA Document Solutions Inc., Osaka (JP)

(72) Inventors: Asami SASAKI, Osaka (JP); Hiroshi YAMAZAKI, Osaka (JP); Ryo TANIGUCHI, Osaka (JP)

(73) Assignee: KYOCERA Document Solutions Inc., Osaka (JP)

(21) Appl. No.: 19/377,895

(22) Filed: Nov. 3, 2025

(30) Foreign Application Priority Data
Nov. 7, 2024 (JP) 2024-194954

(51) Int. Cl. G03G 15/08; G03G 15/00

(52) U.S. Cl. CPC G03G 15/0877; G03G 15/0853; G03G 15/0889; G03G 15/0891; G03G 15/5058; G03G 2215/0607

(57) ABSTRACT

An image forming apparatus includes an image carrying member, a charging device, an exposure device, a developing device, a toner container, a toner concentration sensor, a toner charge amount detection portion, and a control portion. The developing device includes a developer carrying member carrying a two-component developer and develops an electrostatic latent image into a toner image. The toner concentration sensor detects a toner concentration in the developing device. The toner charge amount detection portion detects a toner charge amount in the developing device. Based on a result of detection by the toner concentration sensor, the control portion controls replenishment of the developing device with the toner from the toner container. Based on the toner charge amount detected by the toner charge amount detection portion, the control portion executes first target value changing control of changing a target value of the toner concentration.

### INCORPORATION BY REFERENCE

This application is based upon and claims the benefit of priority from the corresponding Japanese Patent Application No. 2024-194954 (filed on Nov. 7, 2024), the entire contents of which are hereby incorporated by reference.

### BACKGROUND

The present disclosure relates to an image forming apparatus provided with an image carrying member, such as a copy machine, a printer, a facsimile, or a multi-functional peripheral having functions thereof, and relates particularly to an image forming apparatus of an intermediate transfer type using a two-component developer containing toner and a carrier.

In an image forming apparatus, an electrostatic latent image formed on an image carrying member formed of a photosensitive member or the like is developed by a developing device so as to be visualized as a toner image. An example of such a developing device adopts a two-component developing method that uses a two-component developer containing a magnetic carrier and toner.

In the two-component developing method, under an influence of the number of sheets printed, environmental (temperature and humidity) fluctuations, a printing mode, a printing rate on an image (a ratio of a printing area to an area allowing image formation), or the like, the developer might deteriorate to change a charging characteristic of the toner in the developer. This makes it impossible for the toner to be sufficiently charged, leading to problems such as a decrease in image density, image fogging, toner scattering, and so on.

### SUMMARY

An image forming apparatus according to one aspect of the present disclosure includes an image carrying member, a charging device, an exposure device, a developing device, a toner container, a toner concentration sensor, a toner charge amount detection portion, and a control portion. The image carrying member includes a photosensitive layer formed on a surface thereof. The charging device charges the surface of the image carrying member to a prescribed surface potential. The exposure device applies light to the image carrying member charged by the charging device so as to form thereon an electrostatic latent image with attenuated electrostatic charge. The developing device includes a developer carrying member carrying a two-component developer containing a magnetic carrier and toner and develops, into a toner image, the electrostatic latent image formed on the surface of the image carrying member. The toner container contains the toner with which the developing device is to be replenished. The toner concentration sensor detects a toner concentration that is a ratio of the toner to the magnetic carrier in the developing device. The toner charge amount detection portion detects a toner charge amount that is a charge amount per unit mass of the toner in the developing device. Based on a result of detection of the toner concentration by the toner concentration sensor, the control portion controls replenishment of the developing device with the toner from the toner container. Based on the toner charge amount detected by the toner charge amount detection portion, the control portion executes first target value changing control of changing a target value of the toner concentration.

### BRIEF DESCRIPTION OF THE DRAWINGS

FIG. 1 is a sectional side view showing an internal configuration of an image forming apparatus according to one embodiment of the present disclosure.

FIG. 2 is a sectional side view of a developing device incorporated in the image forming apparatus according to the embodiment.

FIG. 3 is a partially enlarged view of and around an image forming portion, which includes control paths of the image forming portion.

FIG. 4 is a graph showing a relationship between a toner concentration and a toner charge amount in a case where a cumulative number of sheets printed is made to vary.

FIG. 5 is a graph showing a relationship between the cumulative number of sheets printed and the toner charge amount in a case where a target value of the toner concentration is changed.

FIG. 6 is a graph showing a relationship between the cumulative number of sheets printed and an image density in a case where the target value of the toner concentration is changed.

FIG. 7 is a graph showing a change amount of the toner concentration with respect to a dot count in second target value changing control.

FIG. 8 is a graph showing the change amount of the toner concentration with respect to the dot count in a case where first target value changing control and the second target value changing control are executed in conjunction with each other.

FIG. 9 is a flow chart showing a procedure for executing the first target value changing control and the second target value changing control in the image forming apparatus according to the embodiment.

### DETAILED DESCRIPTION

### [1. Overall Configuration of Image Forming Apparatus]

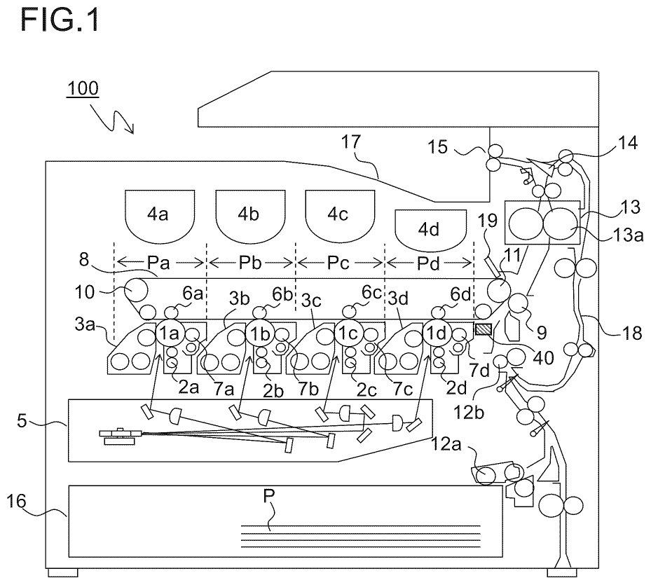

With reference to the appended drawings, the following describes an embodiment of the present disclosure. FIG. 1 is a sectional view showing an internal structure of an image forming apparatus 100 according to one embodiment of the present disclosure. In a main body of the image forming apparatus 100 (herein, a color printer), four image forming portions Pa, Pb, Pc, and Pd are disposed in this order from an upstream side in a conveyance direction (a left side in FIG. 1). The image forming portions Pa to Pd are provided so as to correspond to images of four different colors (cyan, magenta, yellow, and black) and sequentially form the images of cyan, magenta, yellow, and black, respectively, through steps of charging, exposure, development, and transfer.

In the image forming portions Pa to Pd, there are respectively disposed photosensitive drums (image carrying members) 1a, 1b, 1c, and 1d that carry visible images (toner images) of the different colors. Moreover, an intermediate transfer belt (an intermediate transfer member) 8 that is driven by a drive motor (not shown) to rotate in a counterclockwise direction in FIG. 1 is provided adjacently to the image forming portions Pa to Pd. Toner images formed respectively on the photosensitive drums 1a to 1d are sequentially and primarily transferred onto the intermediate transfer belt 8 moving in contact with the photosensitive drums 1a to 1d so as to be superimposed on each other. After that, by a secondary transfer roller 9, the toner images thus primarily transferred onto the intermediate transfer belt 8 are secondarily transferred onto a transfer sheet P as one example of a recording medium. Moreover, the transfer sheet P onto which the toner images have been secondarily transferred is, after the toner images are fixed thereto at a fixing portion 13, discharged from the main body of the image forming apparatus 100. An image forming process with respect to each of the photosensitive drums 1a to 1d is executed while the photosensitive drums 1a to 1d are rotated in a clockwise direction in FIG. 1.

The transfer sheet P onto which toner images are to be secondarily transferred is housed in a sheet cassette 16 arranged at a bottom in the main body of the image forming apparatus 100. The transfer sheet P is conveyed to a nip between the secondary transfer roller 9 and a driving roller 11 of the intermediate transfer belt 8 via a paper feed roller 12a and a registration roller pair 12b. A non-seamed (seamless) belt formed of a dielectric resin sheet is primarily used as the intermediate transfer belt 8. Furthermore, a blade-shaped belt cleaner 19 for removing residual toner or the like remaining on a surface of the intermediate transfer belt 8 is arranged on a downstream side of the secondary transfer roller 9.

Next, a description is given of the image forming portions Pa to Pd. Around and below the photosensitive drums 1a to 1d rotatably disposed, there are provided charging devices 2a, 2b, 2c, and 2d that charge the photosensitive drums 1a to 1d, respectively, an exposure device 5 that performs exposure based on image information with respect to the photosensitive drums 1a to 1d, developing devices 3a, 3b, 3c, and 3d that form toner images on the photosensitive drums 1a to 1d, respectively, and cleaning devices 7a, 7b, 7c, and 7d that remove a residual developer (toner) or the like remaining on the photosensitive drums 1a to 1d, respectively.

Upon an input of image data from a host apparatus such as a personal computer, first, the charging devices 2a to 2d uniformly charge the surfaces of the photosensitive drums 1a to 1d, respectively. Then, the exposure device 5 applies light thereto in accordance with the image data so that electrostatic latent images corresponding to the image data are formed on the photosensitive drums 1a to 1d. Each of the developing devices 3a to 3d is filled with a prescribed amount of a two-component developer containing toner of a corresponding one of the different colors of cyan, magenta, yellow, and black. When, through after-mentioned formation of toner images, a ratio of the toner in the two-component developer filled in any of the developing devices 3a to 3d falls below a preset value, the any of the developing devices 3a to 3d is replenished with toner from a corresponding one of toner containers 4a to 4d. The toner in the developer is supplied onto the photosensitive drums 1a to 1d by the developing devices 3a to 3d, respectively, and is electrostatically deposited thereon. Thus, there are formed toner images corresponding to the electrostatic latent images formed by exposure to light from the exposure device 5.

Further, primary transfer rollers 6a to 6d apply an electric field of a prescribed transfer voltage between themselves and the photosensitive drums 1a to 1d, respectively, and thus the toner images of cyan, magenta, yellow, and black formed respectively on the photosensitive drums 1a to 1d are primarily transferred onto the intermediate transfer belt 8. These images of the four colors are formed in a prescribed positional relationship that is predetermined for formation of a prescribed full-color image. After that, in preparation for subsequent formation of new electrostatic latent images, residual toner or the like remaining on the surfaces of the photosensitive drums 1a to 1d after primary transfer is removed by the cleaning devices 7a to 7d, respectively.

The intermediate transfer belt 8 is stretched between a driven roller 10 on an upstream side and the driving roller 11 on a downstream side. As the driving roller 11 is driven to rotate by the drive motor (not shown), the intermediate transfer belt 8 starts to rotate in the counterclockwise direction, and thus the transfer sheet P is conveyed at prescribed timing from the registration roller pair 12b to the nip (a secondary transfer nip) between the driving roller 11 and the secondary transfer roller 9 provided adjacently to the driving roller 11. While the transfer sheet P passes through the secondary transfer nip, the toner images on the intermediate transfer belt 8 are secondarily transferred onto the transfer sheet P. The transfer sheet P onto which the toner images have been secondarily transferred is conveyed to the fixing portion 13.

The transfer sheet P conveyed to the fixing portion 13 is heated and pressed by a fixing roller pair 13a so that the toner images are fixed to a surface of the transfer sheet P, and thus the prescribed full-color image is formed thereon. A conveyance direction of the transfer sheet P on which the full-color image has been formed is switched by a branch portion 14 branching into a plurality of directions, and thus the transfer sheet P is directly (or after being sent to a double-sided conveyance path 18 and thus subjected to double-sided printing) discharged onto a discharge tray 17 by a discharge roller pair 15.

On a downstream side of the image forming portion Pd, an image density sensor 40 is arranged at a position opposite to the intermediate transfer belt 8. As the image density sensor 40, an optical sensor is typically used that includes a light-emitting element formed of an LED or the like and a light-receiving element formed of a photodiode or the like. To measure an amount of toner deposited on the intermediate transfer belt 8, measurement light is applied from the light-emitting element to reference images formed on the intermediate transfer belt 8 and then becomes incident on the light-receiving element as light reflected by the toner and light reflected by the belt surface.

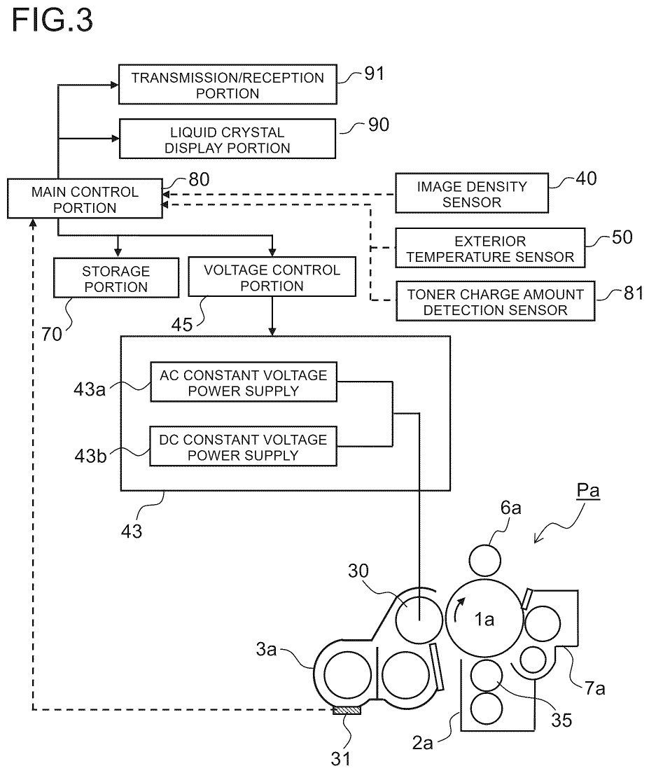

The lights reflected from the toner and the belt surface each include a specular reflection light component and a diffused reflection light component. The specular and diffused reflection light components are split with a polarization splitting prism and then become incident on separate light-receiving elements. The light-receiving elements perform photoelectric conversion on the received specular and diffused reflection light components and output signals to a main control portion 80 (see FIG. 3). Further, a toner amount is detected from a change in characteristics of the output signals related to the specular and diffused reflection light components, and based on a comparison thereof with a predetermined reference density, a characteristic value or the like of a developing voltage is adjusted so that density correction (calibration) is performed for each of the different colors.

### [2. Configuration of Developing Device]

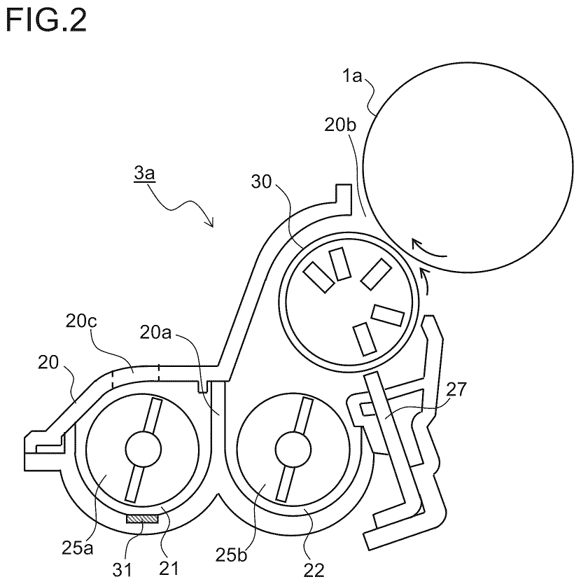

FIG. 2 is a sectional side view of the developing device 3a incorporated in the image forming apparatus 100 according to the embodiment. While the following exemplarily describes the developing device 3a arranged in the image forming portion Pa in FIG. 1, the developing devices 3b to 3d arranged in the image forming portions Pb to Pd, respectively, are also basically similar in configuration to the developing device 3a and thus are omitted from the description.

As shown in FIG. 2, the developing device 3a includes a developing container 20 for storing a two-component developer (hereinafter, may also be referred to simply as a developer) containing a magnetic carrier and toner. The developing container 20 is partitioned by a partition wall 20a into a stirring conveyance chamber 21 and a supply conveyance chamber 22. In the stirring conveyance chamber 21 and the supply conveyance chamber 22, there are respectively and rotatably disposed a stirring conveyance screw 25a and a supply conveyance screw 25b for mixing and stirring toner supplied from the toner container 4a (see FIG. 1) with the magnetic carrier so that the toner is charged.

Further, by the stirring conveyance screw 25a and the supply conveyance screw 25b, the developer is, while being stirred, conveyed in an axis direction (a direction perpendicular to a drawing plane of FIG. 2) and circulates between the stirring conveyance chamber 21 and the supply conveyance chamber 22 via unshown developer passages formed at both ends of the partition wall 20a. That is, in the developing container 20, a developer circulation path is formed by the stirring conveyance chamber 21, the supply conveyance chamber 22, and the developer passages.

The developing container 20 extends to a diagonally upper right side in FIG. 2, and in the developing container 20, a developing roller 30 is arranged on a diagonally upper right side of the supply conveyance screw 25b. A part of an outer circumferential surface of the developing roller 30 is exposed through an opening 20b of the developing container 20 and opposed to the photosensitive drum 1a. The developing roller 30 rotates in a counterclockwise direction in FIG. 2.

The developing roller 30 is composed of a cylindrical developing sleeve that rotates in the counterclockwise direction in FIG. 2 and a magnet (not shown) with a plurality of magnetic poles secured inside the developing sleeve. While the developing sleeve used herein has a knurled surface, it is also possible to use a developing sleeve having a surface with a multitude of concaves (dimples) formed therein, a developing sleeve having a blasted surface, a developing sleeve processed by blasting in addition to knurling and concave formation, and a developing sleeve processed by plating.

Furthermore, the developing container 20 includes a regulation blade 27 mounted along a longitudinal direction of the developing roller 30 (the direction perpendicular to the drawing plane of FIG. 2). A slight gap is formed between a distal end of the regulation blade 27 and a surface of the developing roller 30.

By a high voltage generation circuit 43 (see FIG. 3), a developing voltage composed of a DC voltage Vslv (DC) and an AC voltage Vslv (AC) is applied to the developing roller 30.

On a bottom surface of the stirring conveyance chamber 21, a toner concentration sensor 31 is arranged to face the stirring conveyance screw 25a. The toner concentration sensor 31 is to detect a ratio of the toner to the carrier in the developer (T/C) and is formed of, for example, a magnetic permeability sensor that detects a magnetic permeability of the developer in the developing container 20. Upon detecting the magnetic permeability of the developer, the toner concentration sensor 31 outputs a voltage value corresponding to a detection result to the after-mentioned main control portion 80 (see FIG. 3), and based on an output value of the toner concentration sensor 31, the main control portion 80 determines a toner concentration.

Such a sensor output value changes in accordance with the toner concentration. That is, as the toner concentration increases, a percentage of the toner to the carrier increases, and an increased ratio of the toner, which is not magnetically conductive, results in a lower output value. On the other hand, as the toner concentration decreases, the percentage of the toner to the carrier decreases, and an increased ratio of the carrier, which is magnetically conductive, results in a higher output value. In accordance with the toner concentration thus determined, the main control portion 80 transmits a control signal to a toner replenishment motor (not shown) so that the stirring conveyance chamber 21 is replenished with a prescribed amount of toner from the toner container 4a (see FIG. 1) via a toner replenishment port 20c.

### [3. Control Paths of Image Forming Portion]

FIG. 3 is a partially enlarged view of and around the image forming portion Pa, which includes control paths of the image forming portion Pa. While the following describes a configuration and the control paths of the image forming portion Pa, the image forming portions Pb to Pd are also similar in configuration and control paths to the image forming portion Pa and thus are omitted from the description.

The developing roller 30 is connected to the high voltage generation circuit 43 that generates an oscillating voltage in which a DC voltage and an AC voltage are superimposed on each other. The high voltage generation circuit 43 includes an AC constant voltage power supply 43a and a DC constant voltage power supply 43b. The AC constant voltage power supply 43a outputs a sinusoidal AC voltage generated from a low-voltage DC voltage modulated in a pulse shape using a step-up transformer (not shown). The DC constant voltage power supply 43b outputs a DC voltage obtained by rectifying a sinusoidal AC voltage generated from a low-voltage DC voltage modulated in a pulse shape using the step-up transformer.

During image formation, the high voltage generation circuit 43 outputs, from each of the AC constant voltage power supply 43a and the DC constant voltage power supply 43b, a developing voltage obtained by superimposing an AC voltage on a DC voltage.

Next, with reference to FIG. 3, a description is given of a control system for the image forming apparatus 100. In the image forming apparatus 100, there is provided the main control portion 80 formed of a CPU or the like. The main control portion 80 is connected to a storage portion 70 composed of a ROM, a RAM, and so on. Based on control programs or control data stored in the storage portion 70, the main control portion 80 controls various portions (the charging devices 2a to 2d, the exposure device 5, the developing devices 3a to 3d, the primary transfer rollers 6a to 6d, the cleaning devices 7a to 7d, the fixing portion 13, the high voltage generation circuit 43, a voltage control portion 45, and so on) in the image forming apparatus 100.

The voltage control portion 45 controls the high voltage generation circuit 43. The voltage control portion 45 may be constituted by the control programs stored in the storage portion 70. An exterior temperature sensor 50 is to detect a temperature outside the image forming apparatus 100 and is installed at, for example, a location near an air intake duct (not shown) on a lateral side of the sheet cassette 16 in FIG. 1, where an influence of heat generating portions is less likely to be exerted.

A liquid crystal display portion 90 and a transmission/reception portion 91 are connected to the main control portion 80. The liquid crystal display portion 90 functions as a touch panel for a user to perform various settings for the image forming apparatus 100 and displays a status of the image forming apparatus 100, an image forming situation, the number of sheets printed, and so on. The transmission/reception portion 91 performs external communication over a telephone network or the Internet.

A toner charge amount detection portion 81 performs individual detection of a charge amount per unit mass of the toner (μC/g, hereinafter, referred to as a toner charge amount) in each of the developing devices 3a to 3d being a component of a corresponding one of the image forming portions Pa to Pd. A method for detecting the toner charge amount will be described later.

### [4. Determination of Target Value of Toner Concentration Based on Toner Charge Amount]

Next, a description is given of determination of a target value of the toner concentration based on the toner charge amount, which characterizes the present disclosure. As described earlier, a change in charging characteristic of the toner in the two-component developer makes it impossible for the toner to be sufficiently charged, leading to the problems such as a decrease in image density, image fogging, toner scattering, and so on.

As a solution thereto, in the present disclosure, the toner charge amount is estimated, and based on a result of estimation of the toner charge amount, the target value of the toner concentration (T/C) in the two-component developer is changed (first target value changing control). Thus, it is possible to maintain the toner concentration in a proper range for a long period of time and thus to suppress a decrease in image density.

### (4-1. Estimation of Toner Charge Amount)

The description is directed first to the method for detecting the toner charge amount by use of the toner charge amount detection portion 81. Reference images (patch images) are developed on the photosensitive drums 1a to 1d, and there is measured a developing current that flows between each of the photosensitive drums 1a to 1d and the developing roller 30 during development of the reference images. Furthermore, the reference images thus developed are primarily transferred onto the intermediate transfer belt 8, and a reflection density of the reference images on the intermediate transfer belt 8 is measured by the image density sensor 40. Since there is a correlation between the developing current and the reflection density of the reference images (a toner conveyance amount), based on the developing current and the reflection density of the reference images, the toner charge amount detection portion 81 can estimate the toner charge amount.

A method for estimating the toner charge amount is not limited to the method using the developing current and the reflection density of the reference images, and there are also other methods that can be used. For example, reference images are developed on the photosensitive drums 1a to 1d, and there is measured a surface potential of each of the photosensitive drums 1a to 1d before and after development. Furthermore, a reflection density of the reference images thus developed is measured by the image density sensor 40. Since there is a correlation between a surface potential difference before and after the development and the reflection density of the reference images, based on the surface potential difference and the reflection density, the toner charge amount detection portion 81 can estimate the toner charge amount.

Alternatively, reference images are developed, with a frequency of the AC voltage Vslv (AC) to be applied to the developing roller 30 changed (to, for example, 3 kHz to 10 kHz), and a reflection density of the reference images thus developed is measured by the image density sensor 40. Further, based on the reflection density of toner images, the toner charge amount can be predicted. In a case where the reflection density decreases (a developing amount decreases) as the frequency increases, the toner charge amount detection portion 81 estimates that the toner charge amount is high.

### (4-2. Relationship Between Toner Concentration and Toner Charge Amount)

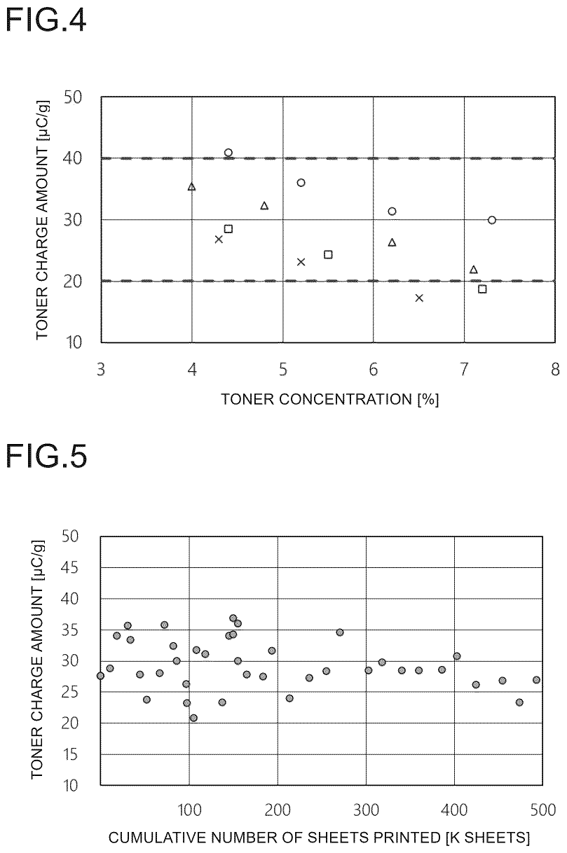

FIG. 4 is a graph showing a relationship between the toner concentration (T/C) and the toner charge amount in a case where a cumulative number of sheets printed is made to vary. As shown in FIG. 4, as the cumulative number of sheets printed increases from 0 (a data series indicated by hollow circles), to 50k (a data series indicated by hollow triangles), to 100k (a data series indicated by hollow squares), and to 150k (a data series indicated by crosses), the toner charge amount decreases. That is, there is a tendency that, as durable printing progresses, the developer (the carrier) deteriorates to decrease the toner charge amount.

Furthermore, when the cumulative number of sheets printed is the same, there is a negative correlation between the toner concentration and the toner charge amount, i.e., there is a tendency that, as the toner concentration increases, the toner charge amount decreases. It is therefore understood that, in order for the toner charge amount to be in a neighborhood of 30 [μC/g], as the durable printing progresses, the toner concentration needs to be decreased.

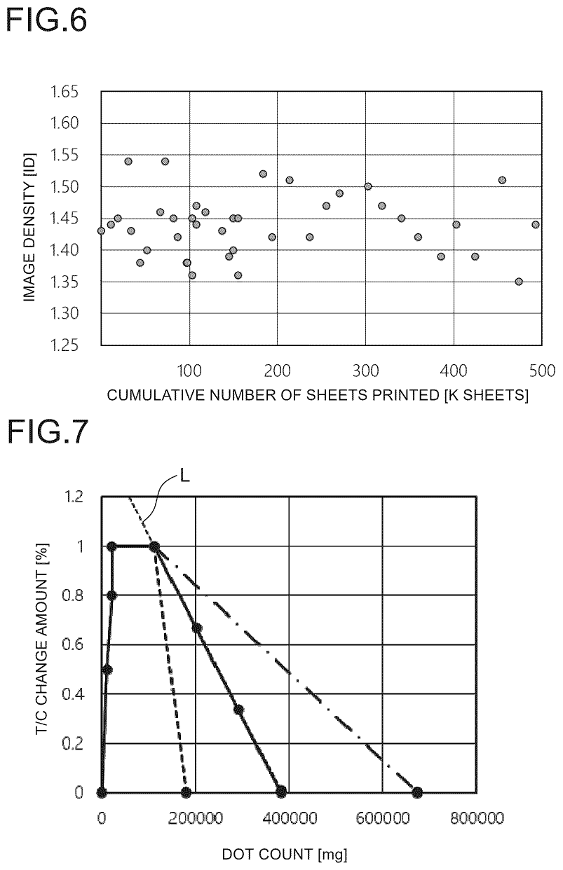

FIG. 5 and FIG. 6 are graphs respectively showing a relationship between the cumulative number of sheets printed and the toner charge amount and a relationship between the cumulative number of sheets printed and the image density in a case where the target value of the toner concentration is changed. Based on the result of estimation of the toner charge amount, the target value of the toner concentration is changed (decreased), and thus as shown in FIG. 5, the toner charge amount is allowed to shift within a range of 20 to 40 [μC/g] throughout an entire range of durable printing of 500k sheets. Furthermore, as shown in FIG. 6, it can be seen that the image density (ID) stably shifts within a range of 1.3 to 1.6 throughout the entire range of durable printing of 500k sheets.

### [5. Determination of Target Value of Toner Concentration Based on Integrated Consumption Amount of Toner]

Furthermore, initial and short-term fluctuations may occur in the toner charge amount, and at an occurrence of such fluctuations in toner charge amount, image performance can hardly be maintained by changing the target value of the toner concentration based on feedback on the result of estimation of the charge amount by the toner charge amount detection portion 81.

To be more specific, in the developer in an initial stage thereof, a toner external additive easily falls off, and the thus liberated external additive is gradually discharged via the photosensitive drums 1a to 1d. When such falling-off of the external additive occurs, the external additive that has fallen off is deposited on a surface of the carrier to cause a decrease in flowability of the developer, thus causing a decrease in bulk density of the developer. This causes the toner concentration sensor 31 to malfunction, outputting a value higher than an actual value of the toner concentration. As a result, there occurs a problem that the toner concentration decreases to decrease the image density. This phenomenon continuously occurs from the initial stage of use of the developer until 500 sheets of images having a printing rate of 5% are outputted.

As described above, the toner concentration decreases depending on an integrated consumption amount of the toner, and thus in conjunction with the above-described first target value changing control, control (second target value changing control) is executed in which the target value of the toner concentration is increased when an integrated printing rate from the initial stage of use of the developer has reached a prescribed value, and is set back to an original value after a lapse of a prescribed period of time.

The integrated consumption amount of the toner can be calculated based on a cumulative value of the number of pixels (a dot count) obtained when an electrostatic latent image is formed by the exposure device 5, the integrated printing rate of an image developed by each of the developing devices 3a to 3d, or an amount of the toner supplied from each of the toner containers 4a to 4d to a corresponding one of the developing devices 3a to 3d. Thus, the second target value changing control is executed based on the dot count, the integrated printing rate, or the amount of the toner supplied.

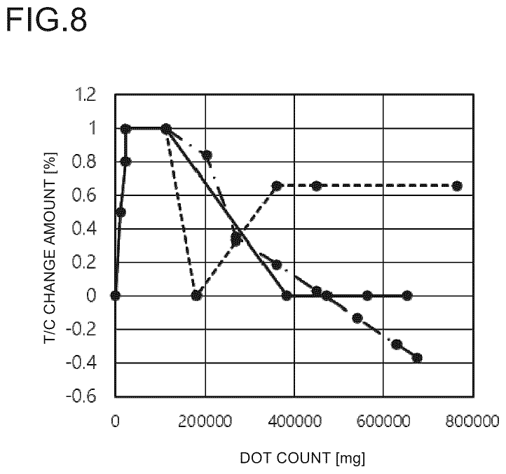

Next, a description is given of a change rate of the toner concentration during execution of each of the first target value changing control and the second target value changing control. While the following describes a case where the second target value changing control is executed based on the dot count, in FIG. 7, FIG. 8, and Table 1 referred to later, the dot count is shown in terms of a mass [mg] of the toner. Where the dot count is indicated by X and a change amount of the toner concentration is indicated by Y, a change rate Z1 of the toner concentration in the first target value changing control and a change rate Z2 of the toner concentration in the second target value changing control are indicated by Z1=Y1/X1 and Z2=Y2/X2, respectively.

FIG. 7 is a graph showing the change amount of the toner concentration (T/C) with respect to the dot count in the second target value changing control. In an example shown in FIG. 7, as the second target value changing control, control is executed in which after an image having a printing rate of 5% is printed on 500 sheets (112,500 mg), the target value of the toner concentration is increased by 1% and, after being kept in a stably shifting state for a prescribed period of time (until 160,000 mg is reached), is set back to an original value (decreased by 1%).

As one example of the first target value changing control, where timing for estimating the toner charge amount is set to every 4,000 sheets of printing at a printing rate of 5% and a change amount of the target value of the toner concentration per control cycle is set to 0.33%, the change rate Z1 of the toner concentration (hereinafter, referred to as a first change rate) during execution of the first target value changing control is plotted as shown by a broken line L in FIG. 7. A solid line in FIG. 7 indicates a case where the change rate Z2 of the toner concentration (hereinafter, referred to as a second change rate) at a time when the target value of the toner concentration that has been increased by 1% is set back to an original value in the second target value changing control is equal to the first change rate Z1 (a 1% decrease per about 300,000 mg).

Furthermore, a dotted line in FIG. 7 indicates a case where the second change rate Z2 is higher than the first change rate Z1 (a 1% decrease per about 100,000 mg). An alternate long and short dashed line in FIG. 7 indicates a case where the second change rate Z2 is lower than the first change rate Z1 (a 1% decrease per about 600,000 mg).

Next, a description is given of a method for setting the second change rate Z2. FIG. 8 is a graph showing the change amount of the toner concentration with respect to the dot count in a case where the first target value changing control and the second target value changing control are executed in conjunction with each other.

When the second change rate Z2 is higher than the first change rate Z1 (a dotted line in FIG. 8), during execution of the second target value changing control, the toner concentration abruptly decreases to abruptly increase the toner charge amount. In such a case, at timing for estimating the toner charge amount in the first target value changing control, the target value of the toner concentration is changed to increase, after which control is performed based only on estimation of the toner charge amount. As a result, disadvantageously, the toner concentration shifts while remaining at a higher level, so that toner scattering becomes likely to occur.

On the other hand, when the second change rate Z2 is lower than the first change rate Z1 (an alternate long and short dashed line in FIG. 8), the toner charge amount shifts at a lower level. In such a case, at the timing for estimating the toner charge amount in the first target value changing control, the target value of the toner concentration is proactively decreased. As a result, disadvantageously, the toner concentration shifts while remaining at a lower level, so that there occurs a decrease in image density.

In contrast, when the second change rate Z2 is set to be equal to the first change rate Z1 (a solid line in FIG. 8), no abrupt change occurs in the toner charge amount, and fluctuations in toner concentration fall within a range controllable by the first target value changing control based on estimation of the toner charge amount. Accordingly, no correction is made to the target value of the toner concentration. Table 1 shows respective values of the toner charge amount in cases where the second change rate Z2 is higher than, equal to, and lower than the first change rate Z1 and control based on a result of estimation of the toner charge amount.

TABLE 1

| | | Toner Charge Amount [μC/g] | | |
|---|---|---|---|---|
| Dot | Second Target | Higher in | Equal in | Lower in |
| Count | Value Changing | Change | Change | Change |
| [mg] | Control | Rate | Rate | Rate |
| 112,500 | When Target Value | 25 | 25 | 25 |
| | Is Increased by 1% | | | |
| 160,000 | When Charge Amount | 35 | 28 | 24 |
| | Is Estimated | | | |
| | Result of Estimation | Control to | No | Control to |
| | | Increase | Correc- | Decrease |
| | | Target Value | tion | Target Value |

Table 1 assumes that, when the dot count from the initial stage of use of the developer reaches 112,500 mg, the second target value changing control is executed to increase the target value of the toner concentration by 1%, and when the dot count reaches 160,000 mg, there is performed estimation of the toner charge amount in the first target value changing control.

It is understood from results shown in FIG. 8 and Table 1 that, in executing the first target value changing control and the second target value changing control in conjunction with each other, the second change rate Z2 needs to be set to be equal to the first change rate Z1.

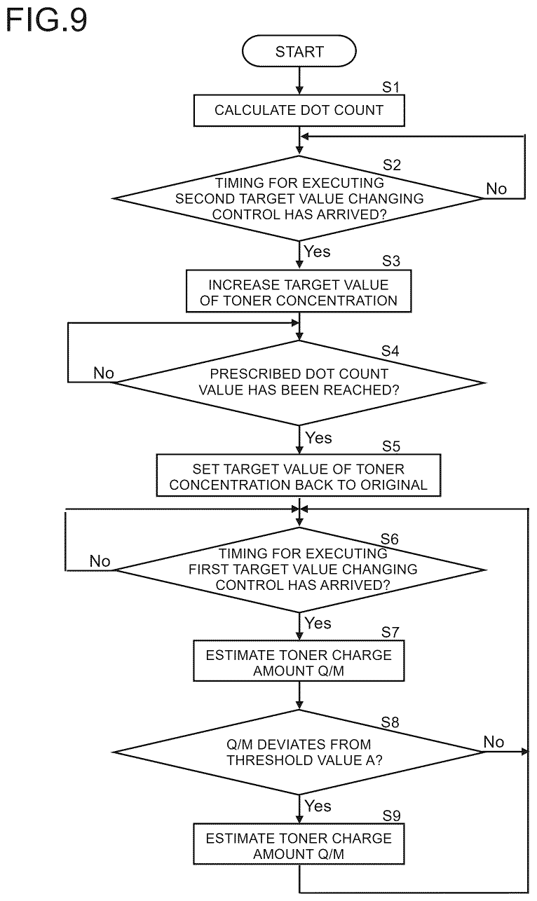

FIG. 9 is a flow chart showing a procedure for executing the first target value changing control and the second target value changing control in the image forming apparatus 100 according to the embodiment. With reference to FIG. 1 to FIG. 8 as necessary, by following steps shown in FIG. 9, a description is given of the procedure for executing the first target value changing control and the second target value changing control.

After a start of use of the image forming apparatus 100, the main control portion 80 executes dot counting during exposure by the exposure device 5 (step S1). Next, the main control portion 80 determines whether or not timing for executing the second target value changing control has arrived (step S2). Specifically, for each of the developing devices 3a to 3d, it is determined whether or not the dot count stored at step S1 has reached a value indicating that an image having a printing rate of 5% has been printed on 500 sheets. In a case where the timing for executing the second target value changing control has arrived for none of the developing devices 3a to 3d (No at step S2), the dot counting is continuously performed.

In a case where the timing for executing the second target value changing control has arrived for at least one of the developing devices 3a to 3d (Yes at step S2), the main control portion 80 performs control in which the target value of the toner concentration is increased by a prescribed value (for example, 1%) in the at least one of the developing devices 3a to 3d for which the timing for executing the second target value changing control has arrived (step S3).

Further, the dot counting is continuously executed, and it is determined whether or not a prescribed dot count value has been reached (step S4). Specifically, it is determined whether or not the dot count has reached a prescribed value (for example, 160,000 dots). In a case where the prescribed dot count value has not been reached (No at step S4), an increased target value of the toner concentration obtained at step S3 is maintained.

In a case where the prescribed dot count value has been reached (Yes at step S4), the increased target value of the toner concentration obtained at step S3 is set back to an original value (step S5). For example, when the target value of the toner concentration has been increased by 1% at step S3, the target value is decreased by 1%. At this time, as shown in FIG. 8, the change rate of the toner concentration at a time when the target value of the toner concentration is set back to an original value (the second change rate Z2) is set to be equal to the first change rate Z1 in the first target value changing control.

After that, the main control portion 80 determines whether or not timing for executing the first target value changing control has arrived (step S6). Specifically, for each of the developing devices 3a to 3d, it is determined whether or not the dot count has reached a value indicating that an image having a printing rate of 5% has been printed on 4,000 sheets. In a case where the timing for executing the first target value changing control has arrived for none of the developing devices 3a to 3d (No at step S6), the dot counting is continuously performed.

In a case where the timing for executing the first target value changing control has arrived for at least one of the developing devices 3a to 3d (Yes at step S6), the main control portion 80 estimates a toner charge amount Q/M in the at least one of the developing devices 3a to 3d for which the timing for executing the first target value changing control has arrived (step S7). Specifically, reference images (patch images) are formed on the photosensitive drums 1a to 1d and then are primarily transferred onto the intermediate transfer belt 8. An image density of the reference images is detected by the image density sensor 40, and a relationship between the image density (the toner conveyance amount) thus detected and a developing current that flows during formation of the reference images is used to estimate the toner charge amount Q/M.

Next, the main control portion 80 determines whether or not the toner charge amount Q/M thus estimated deviates from a threshold value A (step S8). The “threshold value A” used in this control example refers to a numerical value range having a prescribed width. In a case where the toner charge amount Q/M deviates from the threshold value A (Yes at step S8), the target value of the toner concentration is changed (step S9). Specifically, the target value of the toner concentration is decreased, with the change amount of the toner concentration per control cycle set to 0.33%. On the other hand, in a case where the toner charge amount Q/M is within the range of the threshold value A (No at step S8), the target value of the toner concentration is not changed.

After that, a return is made to step S6, and thus the control of changing a toner target value in the first target value changing control is continuously performed (steps S6 to S9).

As shown in FIG. 9, the first target value changing control and the second target value changing control are performed in conjunction with each other, and thus it is possible to properly set the target value of the toner concentration in consideration of both initial and short-term fluctuations in toner charge amount and long-term fluctuations in toner charge amount. Consequently, it is possible to effectively suppress an image density defect due to a decrease in toner concentration in the developing devices 3a to 3d and toner scattering due to an increase in toner concentration therein.

While the description given with reference to FIG. 9 is directed to a case where the second target value changing control is executed based on the dot count, a description quite similar to the above can also be given of a case where the second target value changing control is executed based on, instead of the dot count, the integrated printing rate or the amount of the toner supplied to each of the developing devices 3a to 3d.

In addition, the present disclosure is not limited to the foregoing embodiment and can be variously modified without departing from the spirit of the disclosure. For example, while the foregoing embodiment has described the image forming apparatus 100 including the developing devices 3a to 3d of a two-component developing type each provided with the developing roller (a developer carrying member) 30 that carries a two-component developer, the present disclosure is not limited thereto. The present disclosure is quite similarly applicable to an image forming apparatus including a developing device having a configuration in which a developer carrying member such as a magnetic roller is further provided between the supply conveyance screw 25b and the developing roller 30, and after a developer is supplied from the supply conveyance screw 25b to the magnetic roller, only toner is supplied from the magnetic roller to the developing roller 30.

Furthermore, while the foregoing embodiment has described the image forming apparatus 100 by use of a color printer shown in FIG. 1 as an example thereof, without being limited to a color printer, the present disclosure is applicable also to an image forming apparatus including a developing device of the two-component developing type, such as a color copy machine, a color multifunctional peripheral, a monochrome printer, a monochrome copy machine, or a monochrome multifunctional peripheral.

The present disclosure is usable in an image forming apparatus of the two-component developing type that uses a two-component developer containing toner and a carrier. Through the use of the present disclosure, it is possible to provide an image forming apparatus capable of properly maintaining a toner concentration in the two-component developer for a long period of time.

What is claimed is:

1. An image forming apparatus, comprising:
an image carrying member that includes a photosensitive layer formed on a surface thereof;
a charging device that charges the surface of the image carrying member to a prescribed surface potential;
an exposure device that applies light to the image carrying member charged by the charging device so as to form thereon an electrostatic latent image with attenuated electrostatic charge;
a developing device that includes a developer carrying member carrying a two-component developer containing a magnetic carrier and toner and develops, into a toner image, the electrostatic latent image formed on the surface of the image carrying member;
a toner container that contains the toner with which the developing device is to be replenished;
a toner concentration sensor that detects a toner concentration which is a ratio of the toner to the magnetic carrier in the developing device;
a toner charge amount detection portion that detects a toner charge amount which is a charge amount per unit mass of the toner in the developing device; and
a control portion that controls, based on a result of detection of the toner concentration by the toner concentration sensor, replenishment of the developing device with the toner from the toner container,
wherein
based on the toner charge amount detected by the toner charge amount detection portion, the control portion executes first target value changing control of changing a target value of the toner concentration.

2. The image forming apparatus according to claim 1, wherein
the control portion executes, in conjunction with the first target value changing control, second target value changing control in which the target value is increased when an integrated consumption amount of the toner from an initial stage of use of the two-component developer has reached a prescribed value, and is set back to an original value after a lapse of a prescribed period of time.

3. The image forming apparatus according to claim 2, wherein
when a change rate of the toner concentration during execution of the first target value changing control is referred to as a first change rate, and a change rate of the toner concentration at a time when the target value is set back to an original value during execution of the second target value changing control is referred to as a second change rate, the second change rate is equal to the first change rate.

4. The image forming apparatus according to claim 2, wherein
the integrated consumption amount is calculated based on a dot count obtained when an electrostatic latent image is formed by the exposure device, an integrated printing rate of an image developed by the developing device, or an amount of the toner supplied from the toner container to the developing device.

5. The image forming apparatus according to claim 1, wherein
based on a developing current that flows between the image carrying member and the developer carrying member when a reference image is developed on the image carrying member and a reflection density of the reference image, the toner charge amount detection portion estimates the toner charge amount.
